(19) United States
(12) Patent Application Publication
(10) Pub. No.: US 2026/0121364 A1
(43) Pub. Date: Apr. 30, 2026

(54) Device Charger Apparatus

(71) Applicant: PM Properties LLC, Concord, CA (US)

(72) Inventors: Peter J Tormey, Concord, CA (US); Michael J Petrin, Pleasant Hill, CA (US)

(73) Assignee: PM Properties LLC, Concord, CA (US)

(21) Appl. No.: 19/362,004

(22) Filed: Oct. 17, 2025

Related U.S. Application Data
(60) Provisional application No. 63/712,878, filed on Oct. 28, 2024.

(51) Int. Cl. H01R 31/06; H01R 27/00; H02J 7/00

(52) U.S. Cl. CPC H01R 31/06; H01R 27/00; H02J 7/70; H02J 7/825; H02J 2207/20; H02J 2207/30

(57) ABSTRACT

A flexible casing including an opening operable to receive a portable electronic device such as a cell phone, said electronic device including a native receptacle for receiving power and other electronic information. The casing includes a native plug, disposed in an edge of the casing and operable to mate with the native receptacle when the casing is placed over the electronic device. A first receptacle, substantially the same as the native receptacle, is disposed in the casing and electrically coupled to the native plug together with a second receptacle disposed in the casing and electrically coupled to the native plug, wherein electricity from either the first or second receptacle is coupled to the native plug.

### PRIORITY

This application claims the benefit of provisional patent application 63/712,878 filed Oct. 28, 2024, which is included, together with its Appendix, by reference as if fully set forth herein.

### BACKGROUND OF THE INVENTION

One problem many people face is the need to charge a mobile device, such as a cell phone, but they do not have a proper charging cable. Often charging cables are available but they do not fit the phone at hand. For example, a person may have a PIXEL phone, but only have access to an APPLE charger with the wrong connector on it.

### SUMMARY OF THE INVENTION

Disclosed herein is a mobile device charging adaptor disposed into the mobile device case. Embodiments include multiple charging ports built into the case which enables a protective case for a mobile device, such as a smart phone, to be used as an adapter for different size charging cable connectors.

As disclosed herein the device protects the phone, while providing a plurality of different charging port such as and the like, integrally incorporated into the case, which itself couples the multiple charging ports USCA, USB, USC, USB-C, or iPhone lightning electronically to the phone charging port, employing a metal charging connector configured to match that of the phone, and by internal circuitry, enabling any particular charging plug to fit into one or more of the receptive charging ports located on the protective phone case. Accordingly, different charging cables could be used to charge the phone in the absence of the original (or native) charging plug matching that of the phone.

This disclosure and its embodiments provide a means to both protect a smart device, including a smart phone, while also providing a plurality of different style charging ports that enable charging and optionally data connectivity to the protected device without a limitation to the device's own original (native) charging/data port. Accordingly, this present disclosure as described and exampled below in several exemplary embodiments, provides convenience to the user when the smart device's requires power and the proper charging coupling cable is not available. In addition, an imbedded inductive power plate can receive power from an external charging power supply instead of using a direct physically inserted charging/data cable. In further embodiments, LED indicator lights embedded in the smart device charging case and corresponding circuitry may be included to indicate the presence of power, charging status and completion of charge or removal of power to the charging case for convenience of the user.

Some embodiments may include audio and other control signal to be connected from the charging cable to the device in the protected case. This may be effectuated by coupling the connector pins without additional circuitry when the audio or other signals are complementary. In certain embodiments, additional circuitry may be employed to couple audio and other signals between the cable and the device. For example, and without limitation impedance matching or signal scaling.

### BRIEF DESCRIPTION OF DRAWINGS

FIG. 1 shows a representation of a physical layout of a device in accordance with the current disclosure.

FIG. 2 shows an electrical schematic diagram of wiring that may be used in some embodiments.

FIG. 3 shows another embodiment according to the current disclosure.

### LEXICOGRAPHY

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “native” generally refers to the connectors supplied with a device. For example, and without limitation, a cell phone may be supplied with a USB type-c charging port and is associated “mating) cable connector.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION OF THE INVENTION

The terms male and female as well as plug and receptacle are illustrative only and are meant to convey matching electrical connectors which may be any structure capable of electrical coupling.

For example, a protective case would have an iPhone male charging plug configured so that when the case is put around the phone, this plug becomes inserted into the native receptacle iPhone charging port, protecting it and making electrical contact with the corresponding pins. Integral to the case would be a plurality of additional non-native receptacles, such as a USC female plug receptacle capable of receiving a male USC charging plug in physical and electrical contact by insertion into the plug void containing one of the receptive plurality of charging ports.

In an exemplary embodiment, a USC charger and male charging plug could be inserted into the corresponding female USC charging port located on the exterior of the port protective case, enabling it to charge an iPhone in the absence of the regular native iPhone electrical male charging plug that would be used by direct insertion into the receptive female charging port of the iPhone in the absence of such case and electrical power coupling adapter.

In a second embodiment, rather than a full protective case with multiple charging ports, a linear bar like adapter containing a plurality of different receptive charging points arranged literally and along at least one exterior side of the linear bar so as to receive one or more receptive charging plugs of one or more configurations of connectors, wherein the bar like adapter has at least one charging plug oriented in an opposite direction to the plurality of receptacles, so as to enable at least one charging plug to be inserted into the phones receptacle charging port, making physical and electrical contact with each of the plurality of charging ports located on the removable exterior linear charging bar.

In another embodiment, the phone charger case has an embedded non-contact inductive charging plate for receiving an external charge from an induction power source external to the phone, upon which the phone and its phone case would be placed to interact and receive electrical power from the electrical induction process and using that power source to power the phones battery in lieu of a physical connection to charging ports. The inductive charging plate may require electronic circuitry to convert induced power to a form usable by the phone.

Yet another embodiment, the phone charging case would include one or a plurality of indicating lights such as LEDs that would show the current status of the phone battery, the charging process or signaling the end of the charging process. For example, and without limitation, one LED would be activated when the phone charging case is connected through anyone of its charging ports to an external power source indicating the successful insertion and reception of power to the power case to reassure the user of an active electrical connection between the power source and the phone. The LED could also be configured in conjunction with a detection circuit to provide illumination to indicate an active charging process is occurring, and changing color or deactivating when a full battery charge is achieved and the phone battery is no longer drawing electrical current from the external power source.

In all embodiments presented herein, the power supplying electronic device case may be configured to otherwise enable proper use of the device, including the position of activating buttons, openings to enable the camera or lenses on a smart phone to be an obstructed and used microphone and speaker openings to accommodate the reception and transmission of sound, and any other buttons or functions normally performed on the smart device, tablet or phone without an outer protective case being present.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### DETAILED DESCRIPTION

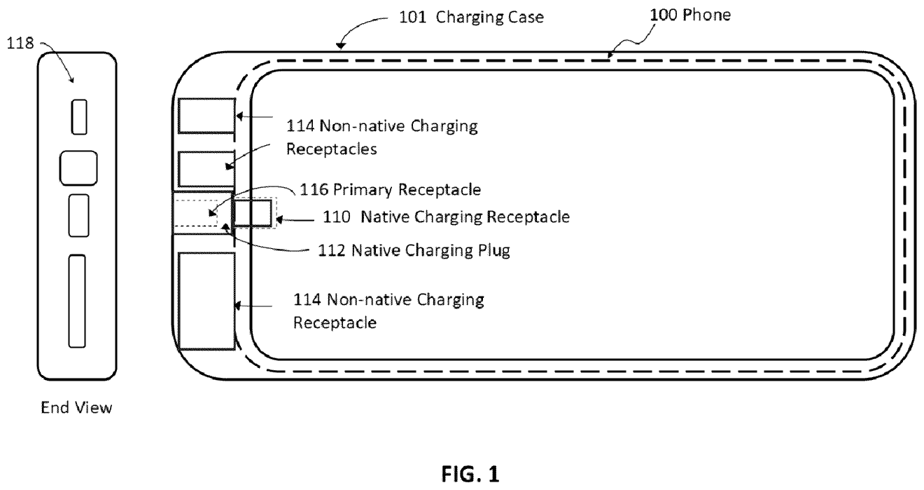

FIG. 1 shows a representation of a physical layout of a device in accordance with the current disclosure. In FIG. 1 a phone (such as a smart phone or similar device) 100 is disposed within a charging case 101. The charging case 101 may be a flexible or semi-rigid casing designed to fit snugly over the phone 100, although in certain embodiments a rigid case may be employed. The phone 100 includes a native charging receptacle 110. The receptacle 110 is the charging port provided by the phone's 100 manufacturer for charging the phone using conventional cables such as a USB type-C cable.

Embedded into the case 101 is a native charging plug 112 operative to mate with the native charging receptacle 110. Coupled to the native charging plug is a primary receptacle 116. The primary receptacle is exposed at one end for receiving a connector from a charging cable (not shown). The primary receptacle 116 may be similar to the native charging receptacle 110, but need not be in all embodiments.

FIG. 1 includes three more non-native charging receptacles 114. These non-native receptacles are operative to receive connectors from charging cables that are different from one that would mate with the primary receptacle 116. Any multiple of non-native charging receptacles may be disposed in the charging case 101. For example, and without limitation, USB, USB Type-A, USB Type-B, mini-USB, and the like. An end view of the bottom of the case 118 shows placement of receptacles in this embodiment.

Embedded in the charging case 101 are electrical connectors (not shown) coupling the native charging plug 112 to the non-native charging receptacles 114 such that a power cable disposed in one of the non-native charging receptacles 114 may provide power to the native charging receptacle 112, thus powering the phone 100 or recharging its battery. In some embodiments, other connections beside power may be similarly coupled such as audio and digital signals.

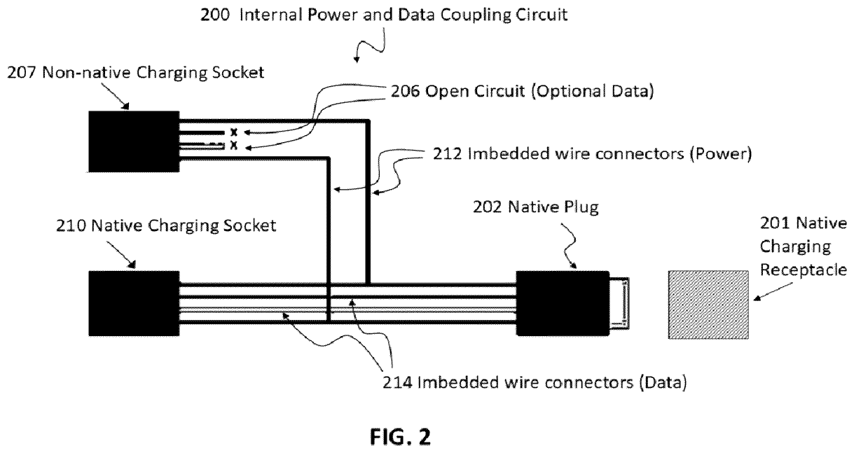

FIG. 2 shows an electrical schematic diagram of wiring that may be used in some embodiments. Native charging receptacle 201 is native to, and provided with a mobile device such as a smart phone. Plug into native charging receptacle 201 is a complementary native plug 202. The native plug 202 is coupled to a native charging socket 210, and one or more non-native charging sockets 207. The non-native charging sockets 217 and the native charging socket 210 are operable to provide power and, in some embodiments, audio and digital signals to the native charging receptacle 201 through the native plug 202.

In operation, the native plug 202 is disposed in a cell phone case. Placing the cell phone in the case allows for insertion of the native plug 202 into the native charging receptacle. The native charging socket 210 provides a way for a matching power connector (not shown) to electrically and physically couple to the native charging receptacle 201 through the native plug 202. Additionally, non-native charging sockets 207, together with the native charging socket 210 are also disposed in the phone case to provide access to a user. In addition to the native charging socket 210, power (or other complementary signals) may be provided to the phone through the native plug 202 and native charging receptacle 201.

One advantage of the embodiments disclosed herein is that a phone with a certain native charging system may be charged using a non-native cable. For example, and without limitation, an ANDROID phone using a USB type-A charging connector may be charged from an IPHONE charging cable with a USB type-C connector. Since multiple non-native sockets may be employed in certain embodiments a phone case with multiple sockets of differing types would provide convenience to the users.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

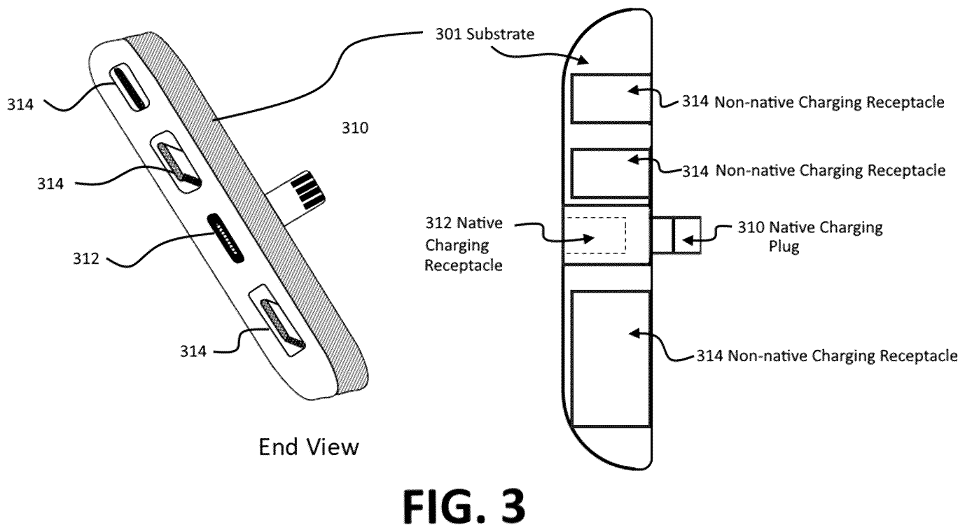

FIG. 3 shows another embodiment according to the current disclosure. In FIG. 3 the connectors are not disposed in the phone case, but are instead formed on a separate substrate for attachment to the phone and native receptacle. A native charging plug 310 is disposed to extend from the body of the substrate 301. The native charging plug 310 is operable to mate with and couple electrical signals to a phone (not shown). Disposed in the native charging plug 310 is a native charging receptacle 312 operable to receive a native charging plug and pass power and other signals to the phone through native charging plug 310.

Further coupled to the native charging plug 310 are non-native receptacles 314. The non-native receptacles 314 are connectors different from the native charging receptacle 312 and used to provide power to the native charging plug 310. Electrically they are coupled to the native charging plug 310 similar to that describe in FIG. 2.

The embodiment of FIG. 3 may attached to a phone using the pressure fit of the native charging plug 310 or is may be physically attached using a strap, VELCRO, or elastic band that may wrap around the mobile device or a phone case and hold the substrate in place. Some embodiments may be form fitted to conform to the shape of the phone and fit snugly.

Other embodiments including embodiments with an Inductive charging pad, circuitry, and details on certain embodiments are included in the attached appendix which is included by reference as if fully set forth herein.

What is claimed:

1. A device including:
a casing, said casing including an opening operable to receive a portable electronic device, said electronic device including a native receptacle;
said casing including a native plug, disposed in an edge of the casing and operable to mate with the native receptacle;
a first receptacle substantially the same as the native receptacle, disposed in the casing and electrically coupled to the native plug;
a second receptacle disposed in the casing and electrically coupled to the native plug,
wherein electricity from either the first or second receptacle is coupled to the native plug.

2. The device of claim 1 wherein the casing is flexible or semi-rigid.

3. The device of claim 1 wherein the first receptacle and the second receptacle are dissimilar.

4. The device of claim 1 wherein the native plug is one of either USCA, USB, USC, or lightning.

5. A casing including:
a first connector having a portion disposed in the casing and a portion extending from a first surface of the casing;
a second connector disposed in the casing and electrically coupled to the first connector;
a third connector disposed in the casing and electrically coupled to the first connector,
wherein electricity applied to either the second or third connector is coupled to the first connector.

6. The casing of claim 4 wherein the first connector and the second connector are complimentary connectors.

7. The casing of claim 4 wherein the first connector is a plug operable to couple with a portable electronic device.

8. The casing of claim 4 wherein the casing is formed to cover a portable electronic device.

9. The casing of claim 4 wherein the connectors are chosen from a group including a USCA, USB, USB-C, or Lightning.

10. The casing of claim 4 wherein the first connector is Lightning and the second connector is USB-C.
